(19) United States
(12) Patent Application Publication
(10) Pub. No.: US 2013/0091802 A1
(43) Pub. Date: Apr. 18, 2013

(54) COFFEE FILTER POUCH MAKER

(71) Applicants: Jonathan Bentley, Sunny Isles Beach, FL (US); Rebecca Bernard, Sunny Isles Beach, FL (US)

(72) Inventors: Jonathan Bentley, Sunny Isles Beach, FL (US); Rebecca Bernard, Sunny Isles Beach, FL (US)

(21) Appl. No.: 13/273,571

(22) Filed: Oct. 14, 2011

(51) Int. Cl. B41F 17/24

(52) U.S. Cl. 53/111 R

(57) ABSTRACT

A coffee filter pouch maker comprising a bean hopper that gravity feeds into an electric bean grinder that ejects grounds into a hopper. A precise manual portioner delivers by gravity feed a predetermined amount of grounds into a filter pouch. Filter pouched are provided on a perforated roll of filter pouches. The filter pouches are sealable. A roll of impermeable bag segments is provided to hold one or more prepared filter pouches. The impermeable bags are vacuumed and sealed with an integrated vac/seal assembly.

### BACKGROUND OF THE INVENTION

1. Field of the Invention

The present invention relates to coffee making, and more particularly, to grinding coffee beans and preparing coffee filter packs for convenient use when away from home and long term storage.

2. Description of the Related Art

Several designs for manufacturing coffee ground bags have been designed in the past. None of them, however, includes a means to receive unground coffee beans integrated with coffee bean grinder that ejects beans into a hopper where a specific volume of the grounds are dispensed into a portion bag and where the portion bags are dispensed from a bulk spool and then sealed, further integrated with a means to vacuum seal the created coffee filter bags inside of an impermeable package.

Applicant believes that the closest reference corresponds to U.S. Pat. No. 2,889,671 issued to Weisman. However, it differs from the present invention because, although the Weisman patent does purport to make and fill coffee filter bags, it lacks the integration of the filler means with the means to grind fresh beans, portion the grounds, seal the filter bag and then vacuum seal the completed coffee filter bag into an impermeable package designed for travel.

Other patents describing the closest subject matter provide for a number of more or less complicated features that fail to solve the problem in an efficient and economical way. None of these patents suggest the novel features of the present invention.

### SUMMARY OF THE INVENTION

It is one of the main objects of the present invention to provide a device that processes coffee from roasted beans to grounds to filter package to hermetically sealed pouch.

It is another object of this invention to provide a device that allows coffee lovers travel with their preferred coffee grounds in a sealed pouch for use in hotel room automatic coffee makers.

It is still another object of the present invention to provide a device that precisely grinds and portions coffee grounds into single use packages for on the go use.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents perspective cross sectional view of in important variation of the device.

FIG. 2 shows a perspective view of the front side of the device.

FIG. 3 illustrates a perspective view of the front side of the device with the front door open.

FIG. 4 is a representation of a perspective view of a portion of the device demonstrating an important version of portioning mechanism.

FIG. 5 shows a perspective view of the side of a variation of the device.

FIG. 6 represents a perspective view of an example of an unsealed filter pouch used in the device.

FIG. 7 is a perspective view showing in more detail a version of a grinder assembly and grounds hopper assembly.

### DETAILED DESCRIPTION OF THE PREFERRED EMBODIMENT

Referring now to the drawings, where the present invention is generally referred to with numeral 10, it can be observed that it basically includes a hopper assembly 12, a grinder assembly 14, a hopper assembly 16, a portioner assembly 18, a vac/seal assembly 24 and a filter assembly 28, all integrated with a case assembly 26.

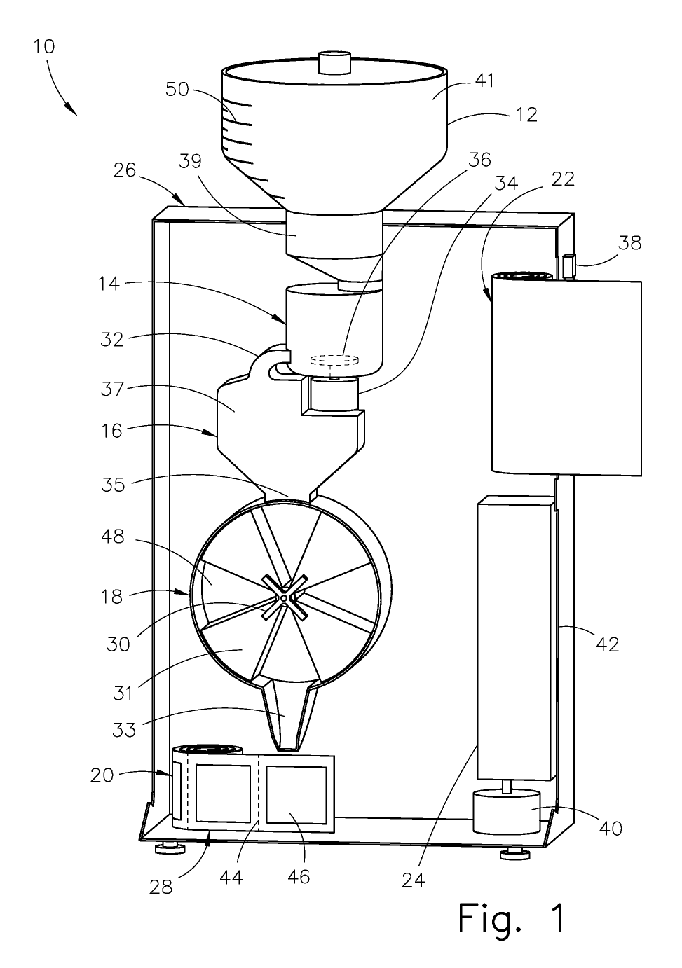

FIG. 1 shows the device in a perspective cross-section frontal view to reveal the inner components of this version of the device that may further include, inter alia, a filter roll 20, a bag roll 22, a filter assembly 28, a portioner handle 30, portioner dividers 31, a grounds chute 32, a chute 33, a grinder motor 34, a chute 35, a grinder blade 36, a grounds hopper 37, a knife carriage 38, a bean hopper 39, a vac motor 40, a supplemental hopper 41, a vac/seal aperture 42, a perforation 44, a filter pocket 46 and a portion cup 48.

Generally, the hopper assembly 12 is comprised of a larger, supplemental hopper 41 and a bean hopper 39. Preferably graduations 50 are present and visible on the sides of the supplemental hopper 41 and optionally, also on the bean hopper 39. In preparing the device for use, unground, roasted coffee beans are placed into the supplemental hopper 41 to the desired level as indicated by the graduations 50.

By utilizing unground, roasted coffee beans, a user of the device can use whichever type and style of beans she desires. Sometimes, mixing different varieties can yield a preferable result based on the predilection of the user. By mixing and matching different whole beans a wide variety of brews can be achieved. This customization of flavors and styles greatly increases the flexibility of the end product to suit the user's taste and preferences.

As shown in FIG. 1 and FIG. 7, the grinder assembly 14 is further comprised of a grinder motor 34, a grinder blade 36 and a grounds chute 32. Gravity pulls the unground beans from the bean hopper 39 into the grinder assembly 14. The beans then fall into the grinder blade 36 that is powered by the grinder motor 34. The force generated by the grinder motor 34 also ejects the grounds created out of the grinder assembly 14, through the grounds chute 32 into the hopper assembly 16.

The hopper assembly 16 is further comprised of a grounds hopper 37 and a chute 35. Once the coffee beans are ground by the grinder assembly 14 and expelled thought the grounds chute 32, the coffee grounds are collected in the grounds hopper 37. Once in the grounds hopper 37 the coffee grounds are in line for portioning, dispensing and packaging as described below.

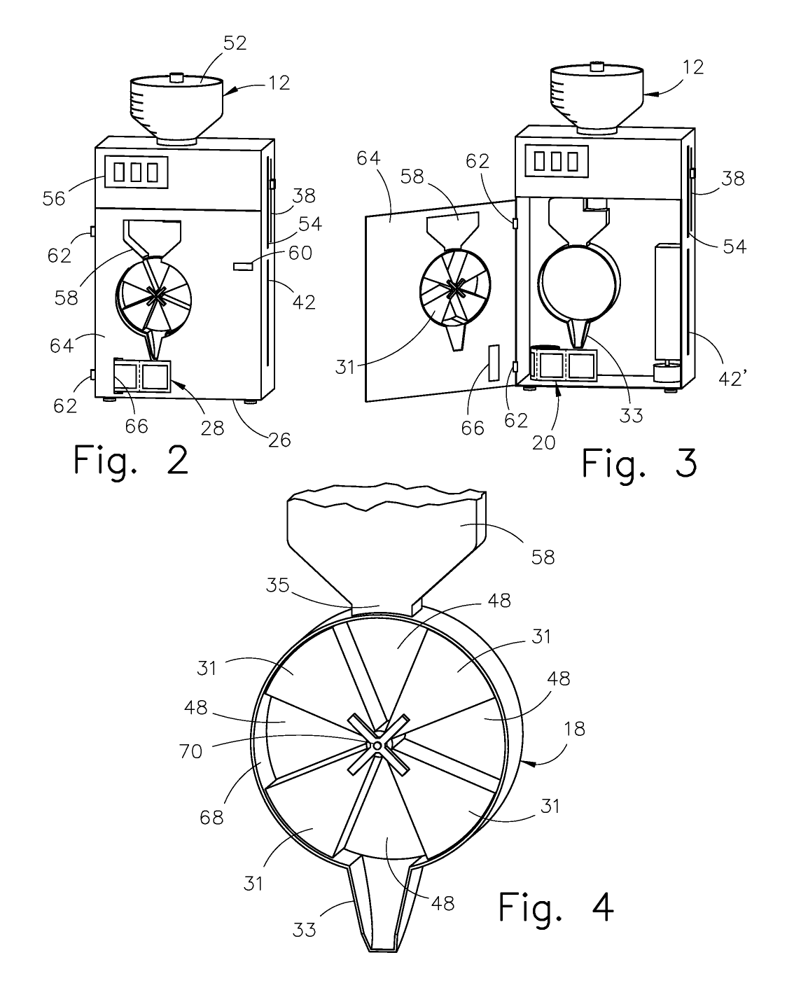

Now looking at FIGS. 2 and 3 where the device is shown to further include a lid 52 on the hopper assembly 12, a knife carriage 38, a vac/seal aperture 42, controls 56, a bag dispenser aperture 54, a window 58, a door latch 60, hinges 62, a door 64 and filter pouch aperture 66. FIG. 2 shows the device configured as it might be set up for normal use in grinding bean and filling filter assemblies 28.

FIG. 2 shows the door 64 closed to seal the front of the case assembly 26. The window 58 allows the user of the device to see through the door 64 and view the functioning of the portioner assembly 18 to ensure proper operation of the device.

The filter roll 20 is comprised of a plurality of filter assemblies 28, connected for easy and rapid dispensation through the filter pouch aperture 66. The position of the filter pouch aperture 66 is such that the filter assemblies 28 are delivered near to and under the chute 33 so that all the dispensed grounds are captured inside the filter bag assembly 28, minimizing any spillage.

The latch 60 provides a handle means to pull open the door 64 of the case assembly 26 about hinges 62, opposite the latch 60. The latch 60 may be embodied by any conventional means of latching commonly known in the art, for example, magnets, hooks or other suitable latch type to keep the door 64 closed during normal operation yet permitting easy access to the interior for maintenance and cleaning.

Controls 56 provide for operation of the various features of the device including, for example, activating the grinder assembly 14 for grinding beans into grounds, activating a vacuum pump and heat sealer that comprise the vac/seal assembly 24. The position of the controls 56 is not critical as long as they are in a convenient position in the case assembly 26. The controls 56 are preferably grouped together but need not necessarily be so.

FIG. 3 shows the door 64 open about hinges 62 to reveal the interior of the case assembly 26 for maintenance and cleaning. The door 64 may be opened to replenish supplies of the filter roll 20 or the bag roll 22 as must be done from time to time, before use.

Referring to FIG. 4, a more detailed view of the portioner assembly 18 shown and further includes, inter alia, a portioner handle 30, several portioner dividers 31, a chute 33, several portion cups 48, a cylinder 68 and an axle 70.

The portioner assembly 18 provides the means to accurately dispense a predetermined volume of grounds from the grounds hopper 37 out through the chute 33 and into a filter bag assembly 28. The portioner is preferably not electrically powered, but may be alternate variations of the device.

In the preferred version of the device, the operator rotates the portioner handle 30 about axle 70. The portioner handle 30 is directly connected to the plurality of portioner dividers 31 and radiate outward from the central axle 70. The portioner dividers 31 are connected to each other under the handle 30. The portioner dividers 31 are dimensioned to fit snugly inside the cylinder 68 to prevent movement of any grounds past the portioner dividers 31 yet permitting substantially free rotational movement of the portioner dividers inside the confines of the cylinder 68.

The portion cups 48 are defined by the volume between adjacent portioner dividers 31. Said volume of the portion cups 48 is predetermined to be a specific volume and each of said portion cups 48 preferably has an equal volume. For example, said portion cup 48 volume may be that equal to the volume of grounds needed to brew two cups of coffee in an automatic coffee maker, such as is found in many hotels rooms for courtesy use. Of course, in some variations it may be preferable to have other volumes ranging from less than that needed for a single cup of coffee to the size needed for multiple cups of coffee.

In typical use, beans are first ground by the grinder assembly 16 and collected prior to portioning in the grounds hopper 37. The operator of the device then positions a first portion cup 48 at top dead center exposing the interior of the portion cup 48 to the chute 35 where gravity fills the first portion cup 48 to capacity. The handle 30 is then rotated so that a second portion cup 48 is then under the chute 35 where it too is filled to capacity by gravity. In the drawings a four portion cup 48 design is shown resulting in a substantially ninety-degree rotation between portion cups 48. Obviously, is more or fewer portions cups 48 were present the degree of rotation between portion cups 48 would necessarily have to be adjusted accordingly.

In the version of the portioner assembly 18 as shown in the drawings with four portion cups 48, and where each portion cup 48 has a volume equivalent to brew two cups of coffee, the operator of the device would place a filter assembly 28 under the chute 33 and turn the handle 30 about ninety degrees for each two cups of grounds desired to be placed into the filter assembly 28. The grounds in the portion cup 48 at bottom dead center fall by gravity into the filter assembly 28 waiting below under the chute 33. Specifically, in this example with the above parameters, to fill a filter assembly 28 with enough grounds to brew six cups of coffee grounds the handle 30 would need to be rotated approximately two-hundred seventy degrees to dispense three filled portion cups 48 into a single filter assembly 28.

FIG. 5 shows a view of a version of the side of the case assembly 26 having further details including, inter alia, a knife carriage 38, a bag dispenser aperture 54, a knife 80, a vac/seal aperture 43 and a cord 72. The version of the device in FIG. 5 is similar to that shown in FIGS. 2 and 3, described infra.

The bag dispenser aperture 54 permits dispensation of bulk bags from a bag roll 22 for use in packaging filled filter assemblies 28 for storage and transport. In typical use of the device, a section of the bag roll 22 of sufficient length is pulled through the bag dispense r aperture 58 and then cut off from the balance of the roll with a knife 80. The knife 80 is operated by the knife carriage 38. The knife carriage 38 is slid from top to bottom so that the knife 80 slices through the bag roll 22. The bag roll 22 is more clearly shown in FIG. 1.

Generally, the bag roll 22 is provided as a consumable accessory to the device. The bag roll 22 may be comprised of many feet of plastic bag material that is provided with the edges sealed along the length of the entire bag roll 22. When a length of bag roll 22 material is selected by pulling the material out from inside of the device through the bag dispenser aperture 54 it is cut free of the balance of the bag roll 22 by the knife 80 by manipulating the knife carriage 38, freeing an individual bag of the selected size.

As an alternative, either or both the filter roll 20 and bag roll 22 may be formed not as a continuous roll but instead as a package of pre-cut, pre-sized material. If in this form a user of the device may pull a respective pre-sized filter assembly 28 or plastic bag material without the need to cut or tear it free from a bulk roll.

Once an individual bag is loose from the bag roll 22 only two opposing factory sealed edges are closed. A third edge of the bag is then inserted into the vac/seal aperture 42 and that edge is then permanently heat sealed closed by activating the appropriate button on the controls 56 (seen best in FIG. 2). The heat seal process welds the plastic that the bag is made of onto itself so that the seal is completely waterproof and hermetically sealed.

After one or several filter assemblies 28 are loaded with the desired amount of coffee grounds they are placed inside a bag with the now three sealed edges. The remaining unsealed edge is inserted into the vac/seal aperture 42 to vacuum out any air inside the bag. The vac motor 40 is activated by the appropriate button on the controls 56 and the air is then drawn from the interior of the bag until the preselected internal pressure is reached. The heat seal button is then selected on and the final seal on the bag is made by welding the bag edge onto itself creating a fully water and air tight bag containing completed coffee filter assemblies 28 full of the right amount of coffee.

A cord 72 is provided to plug the device into standard household electricity to power the grinder assembly 14 and the vac/seal assembly 24. The power may also power other accessories such as a clock or timer as needed.

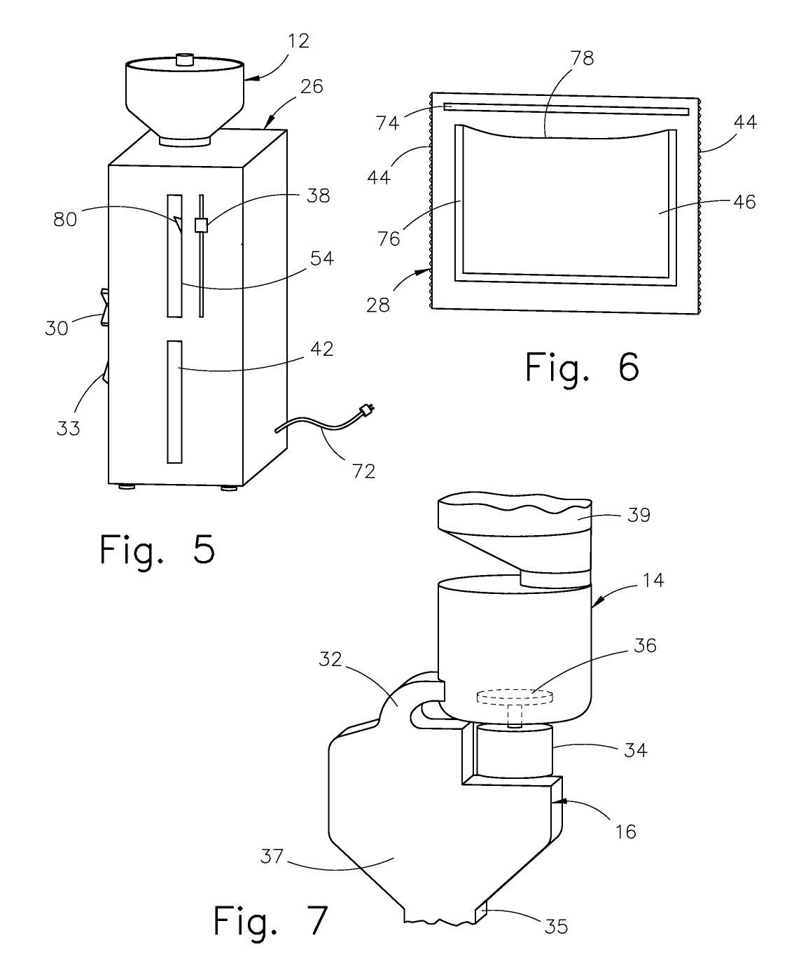

FIG. 6 is a detailed view of an example of filter assembly 28 that includes, inter alia, perforations 44, a filter pocket 46, an adhesive 74, a margin 76 and an aperture 78. A filter pocket 46 of filter material is formed to hold coffee grounds bounded by margins 76 which form the bottom and sides of the filter pocket 46.

Preferably, the filter pocket is made of a permeable membrane adapted so that the smallest of the coffee grounds particles cannot pass through yet water is permitted to easily pass during the brewing process. A non-woven fabric may be suitable for some applications. In others, a heat melt-able material may be preferred if the filter pocket 46 is to be heat sealed. In other variations a material similar to that commonly used in tea bags or traditional coffee filters may be effective either alone or in combination with other materials.

Preferably, the filter assemblies 28 are provided in bulk as a consumable supply in a filter roll 20. The individual filter assemblies 28 are fed through the filter pouch aperture 66 where they are positioned under the chute 33 in preparation for filling with coffee grounds through the aperture 78. Once the grounds have been dispensed the filter assembly 28 is separated from the adjacent filter assembly 28 on the filter roll 20 at perforations 44.

The filter pocket 46 is then sealed to contain the grounds by folding over the top of the filter assembly 28 to adhere the top edge to the face of the filter pocket by means of the adhesive 74. Other means to seal the filter pocket could be readily used. For example, the vac/seal assembly 24 could be used to heat seal the filter pocket 46 similar to how the bag is sealed.

FIG. 7 is a close up view of a portion of the grinder assembly 14 and the hopper assembly 16, including, inter alia, a grounds chute 32, a grinder motor 34, a chute 35, a grinder blade 36, a grounds hopper 37 and a bean hopper 39.

Once the hopper assembly 12 is filled with the pre-determined mixture and amount of beans the user activates the grinder assembly 14 by pressing the appropriate button on the controls 56. The grinder motor 34 is activated and the beans are pulverized into grounds.

To effectively use the device, a person would typically select and / or mix roasted coffee beans in a measured quantity sufficient to brew a quantity of coffee. The whole beans are then placed into the hopper assembly 12 and the estimated volume of beans is re-verified against the graduations 50 on the side of the hopper assembly 12. The grind button on the panel 56 is depressed to initiate grinding of the beans. As the whole beans are ground they are ejected through the grounds chute 32 and into the grounds hopper 37. Once all the beans are ground or the grounds hopper 37 is full the grinding is ceased. A filter assembly 28 is extended from the filter roll 20 through the filter pouch aperture 66 and the first filter pouch 46 is placed under the chute 33. The portioner handle 30 is rotated ninety degrees for each portion of coffee grounds to be placed inside the filter pouch 46. In this example, the handle 30 is rotated two hundred seventy degrees (three quarters) around so that three two-serving portions are delivered into the filter pouch 46. The perforations 44 are torn so that the now filled filter assembly 28 is separated from the remaining unfilled filter assemblies 28 remaining on the filter roll 20. The adhesive 74 is activated and folded over onto the top of the filter pocket 46 to seal the measured grounds into the filter pocket 46. Additional completed filter assemblies 28 are similarly created. A segment of bag from the bag roll 22 is withdrawn and cut off of the bag roll 22. One of the two unsealed edges of the bag is welded closed by the vac / seal assembly 24. Several completed filter assemblies 28 are put into the bag, the air is vacuumed from the bag and the remaining edge is welded shut thereby hermetically sealing the fresh grounds in the filter assemblies 28 into the bag. When needed, the sealed bag is opened and used to brew a fresh pot of coffee in, for example, a hotel room where quality coffee grounds are otherwise unavailable and a great cup of coffee is produced.

The device can also be fairly described as being a coffee processing device comprising a bean hopper that holds beans that are fed into a grinder that in turn feeds the resulting grounds into a grounds hopper. A portioner puts a precise volume of grounds into a pocket on a roll of filter assemblies. A bag roll dispenses impermeable bags into which the filter assemblies are sealed and stored. A vac/seal assembly vacuums the air out of the impermeable bag and seals out any air which can cause degradation of the coffee grounds. The filter roll is comprised of a plurality of substantially identical, water permeable filter assemblies. Each of the filter assemblies has a substrate backing and a filter pocket partially attached to the substrate backing adapted to contain and seal within a predetermined volume of coffee grounds. It could be made of a material similar to that of a conventional non-woven coffee filter or other suitable material. The filter roll could be comprised of a series of filter assemblies, each connected to the next by perforations to separate the filter assemblies. If in this form, the substrate backing bears some resemblance to a roll of toilet paper, in form if not material, with each segment of filter assembly also having a pocket to accept coffee grounds. Alternatively, the individual filter assemblies might not be connected successively but individually formed and dispensed in a manner more similar to a box of tissues or common c-fold paper towels, thus having more of a box dispenser character than a roll character. The bag roll is comprised of a plurality of predetermined bag segments, each constructed of an impermeable material, such as plastic, adapted to contain at least one filter assembly and adapted to be vacuum sealable. The bean hopper dimensioned to contain a predetermined quantity of whole, roasted coffee beans and adapted to deliver said coffee beans via a chute and into said grinder by means of gravity. The electrically powered grinder is adapted to grind said coffee beans into coffee grounds and eject said coffee grounds via a chute into said grounds hopper. The portioner is adapted to receive a preselected volume of said coffee grounds from said grounds hopper by means of gravity and a portioning action, preferably effectuated by manually turning a handle, is adapted to selectively dispense and deliver a specific, predetermined volume of coffee grounds into the filter pocket on a filter assembly. The filter pocket is dimensioned and adapted to receive a predetermined plurality of said preselected volumes, possibly on the order of about one to twelve portions, of coffee grounds. The impermeable bag segments are dimensioned to contain a predetermined quantity of sealed filter assemblies, possibly on the order of about one to ten filled filter assemblies (or enough needed for the traveler's needs). The vac/seal assembly is adapted to vacuum seal said bag segment containing said filter pockets and to hermetically seal said filter assemblies inside of said bag segment.

In a preferred version, for each partial turn of the portioner handle a specific preselected volume of said portioner delivers between about one quarter ounce to four ounces of coffee grounds into said filter pocket per said portioning action. Generally, the portioner has several cups, each of which is filled by gravity from the grounds hopper and is then leveled off to full and turned upside down to deliver the grounds to the filter pocket on the filter assembly.

Other variations include that filter pocket seal is either heat sealed or by means of an adhesive strip. When heat sealed it may be done by the vac/seal assembly further adapted to be able to heat seal said filter pockets after filling with coffee grounds.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A coffee processing device comprising a bean hopper, a grinder,
a grounds hopper, a portioner, a bag roll, a filter roll and a vac/seal assembly;
Said filter roll is comprised of a plurality of substantially identical, water permeable filter assemblies, each having a substrate and a filter pocket adapted to contain and seal within a predetermined volume of coffee grounds;
Said bag roll is comprised of a plurality of predetermined bag segments, each constructed of an impermeable material, adapted to contain at least one filter assembly and adapted to be vacuum sealable;
Said bean hopper dimensioned to contain a predetermined quantity of whole coffee beans and adapted to deliver said coffee beans into said grinder by means of gravity;
Said grinder is electrically powered and is adapted to grind said coffee beans into coffee grounds and eject said coffee grounds into said grounds hopper;
Said portioner is adapted to receive a preselected volume of said coffee grounds from said grounds hopper by means of gravity;
Said portioner has a portioning action that is adapted to selectively dispense and deliver said preselected volume of coffee grounds into said filter pocket on a preselected filter assembly;
Said filter pocket is dimensioned and adapted to receive a predetermined plurality of said preselected volumes of coffee grounds;
Said bag segments are dimensioned to contain a predetermined quantity of sealed filter assemblies;
Said vac/seal assembly is adapted to vacuum seal said bag segment containing said filter pockets and to hermetically seal said filter assemblies inside of said bag segment.

2. A coffee processing device as disclosed in claim 1 further characterized in that said preselected volume of said portioner delivers between about one quarter ounce to four ounces of coffee grounds into said filter pocket per said portioning action.

3. A coffee processing device as disclosed in claim 1 further characterized in that said filter pocket seal means is either heat sealed or by means of an adhesive strip.

4. A coffee processing device as disclosed in claim 1 further characterized in that said vac/seal assembly is further adapted to be able to heat seal said filter pockets after filling with coffee grounds.
